(19) United States
(12) Patent Application Publication
(10) Pub. No.: US 2024/0185820 A1
(43) Pub. Date: Jun. 6, 2024

(54) ELECTRONIC TEMPO TRAINER

(71) Applicant: Reed Searle, Albuquerque, NM (US)

(72) Inventor: Reed Searle, Albuquerque, NM (US)

(21) Appl. No.: 18/075,436

(22) Filed: Dec. 6, 2022

(51) Int. Cl. G10H 1/00; G09B 15/00; G10H 1/045

(52) U.S. Cl. CPC G10H 1/0008; G09B 15/003; G10H 1/045; G10H 2210/091

(57) ABSTRACT

A tempo trainer includes a plurality of lights displayed on a front display surface of a housing in the form of at least one of a line or a circle and including a center light. A beat can be set for an electronic metronome. An attack from a musical instrument can be compared with the beat using a phase comparator. The difference in phase between the beat and the attack can be determined by the phase comparator. The difference in phase (time-difference) between a beat of an electronic metronome and an attack of a musical instrument can be displayed by the plurality of lights. The plurality of lights can visually display the difference with at least one or a portion of the plurality of lights becoming lit either ahead of, at, or after a center light to indicate whether a musician operating the musical instrument is playing ahead of, at, or after the beat of the electronic metronone.

### TECHNICAL FIELD

The present embodiments are generally related to systems and methods of guiding musician tempo when playing music and for use as a training aid. More particularly, the embodiments are related to an electronic tempo trainer that can electronically compare a beat set for an electronic metronome and an attack received from a musical instrument to determine a difference in phase and can then display the difference visually on a display.

### BACKGROUND

A metronome is a device that produces an audible click or other sound at a regular interval that can be set by the user, typically in beats per minute (BPM). Metronomes may include synchronized visual motion. Musicians use the device to practice playing to a regular pulse. Mechanical, wind-up metronomes were commonly used as a tool for musicians in the nineteenth century and still exist today. In the later 20th century, electronic metronomes and software metronomes were invented.

Musicians practice with metronomes to improve their timing, especially the ability to stick to a regular tempo. Metronome practice can help internalize a clear sense of timing and tempo. Composers and conductors often use a metronome as a standard tempo reference- and may play, sing, or conduct to the metronome. The metronome is used by composers to derive beats per minute if they want to indicate that in a composition. Conductors use a metronome to note their preferred tempo in each section. When interpreting emotion and other qualities in music, performers seldom play exactly on every beat; expressive, flexible rubato may be used at times. Typically, every beat of a musically expressive performance does not align exactly with each click, especially of a mechanical metronome. This has led some musicians to criticize use of a metronome, because metronome time is different from musical time.

Most modern metronomes are electronic and use a quartz crystal to maintain accuracy, comparable to those used in wristwatches. The simplest electronic metronomes have a dial or buttons to control the tempo; some also produce tuning notes, usually around the range of A440 (440 hertz). Sophisticated metronomes can produce two or more distinct sounds. Tones can differ in pitch, volume, and/or timbre to demarcate downbeats from other beats, as well as compound and complex time signatures. Many electronic keyboards have built-in metronome functions. Software metronomes run either as standalone applications on computers and smartphones, or in music sequencing and audio multitrack software packages. In recording studio applications, such as film scoring, a software metronome may provide a click track to synchronize musicians.

The metronome is usually positively viewed by performers, musicologists (who spend considerable time analyzing metronome markings), teachers, and conservatories. It is considered an excellent practice tool because of its steady beat, being mathematically perfect and categorically correct. Current metronomes are limited, however, because they cannot visually display the time-difference between the beat of a metronome and an attack of a musical instrument. What is needed is a training device that can be utilized for musicians who are developing an “ear” for the beat of music to easily understand if they are playing ahead of the beat or behind the beat.

### SUMMARY OF THE EMBODIMENTS

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

What is presented herein is a new device in the form of an electronic tempo trainer that visually displays the time-difference between the beat of a metronome and the attack of a musical instrument. The purpose is as a training device for musicians who are developing an “Ear” for the beat of music and need assistance to understand if they are playing ahead of the beat or behind the beat.

In accordance with a feature of the embodiments, a musician can interact with an electronic tempo trainer by plugging an instrument or other audio input device (e.g., microphone) into the electronic tempo trainer (e.g., typically utilizing a ¼″ input Jack). The musician can then set a metronome tempo with a rotary knob. Pushing this same knob can start and stop operation of the metronome. When the musician plays the instrument, this can create what can be referred to as an “Attack.” The core of the electronic tempo trainer can be a phase comparator. The phase comparator can detect the difference in phase between the metronome signal and the Attack. The phase comparator can measure both the magnitude of the difference in phase, and a before-after value representative of the musician's attack being either before or after the metronome's beat (tempo). Once these two values are known, they can then be displayed using lights for the musician to see.

In accordance with another feature of the embodiments, a first jack can be provided for plugging in the audio input (e.g., instrument, amplifier, electronic mixer, microphone), and a second jack can be provided for pass-through signal capabilities (e.g., input to an amplifier or an audio signal mixer). For example, an instrument can be plugged directly into the metronome, or the instrument can first be plugged into an amplifier and then into the metronome. Other configurations are possible.

In accordance with another feature of the embodiments, a display can be provided on the electronic tempo trainer as a row of lights.

In accordance with yet another feature of the embodiment, lights can be provided in any form including incandescent lights, LEDs, Addressable LEDs, etc. The center light of a row can flash with the metronome beat giving the musician a target for their playing. Lights on either side of a center light can light depending on when the musician played the instrument. Colors can be chosen to indicate at least one of four possibilities: 1) Center Light—metronome beat but musician missed the beat or isn't playing; 2) Center Light—metronome beat AND musician played on time; 3) Left Lights—Musician played early, or before the beat; 4) Right Lights—Musician played late, or after the beat.

In accordance with another embodiment, a circle of lights can be provided and can provide additional information to the musician. A similar lighting/color scheme as mentioned above for a row of lights can apply here; however, a full circle can allow the musician to view their accuracy when playing multiple times per beat. For example, most musicians set the tempo of the metronome as a quarter note. Thus, when playing eighth notes, two lights can light up per beat. For triplets, three lights can light up and for sixteenth notes, four lights can light up. The pattern on the circle can indicate to the musician how accurately they were playing their instrument.

In accordance with yet another feature of the embodiments, a spinning disk and a strobe light can be used for the display. The spinning disk can spin at a constant rotational speed while the strobe can flash at a rate to make a pattern etched on the disk move clockwise (ahead of the beat) or counterclockwise (behind the beat). The rate of apparent spin can be proportional to the difference between the attack and the beat.

In accordance with another embodiment, features of an electronic tempo trainer as described herein can also be embodied in the form of a smartphone application. Instead of plugging the instrument in, the application can utilize a smartphone's microphone to listen for an attack and compare it to a beat set using the user interface (e.g., the touch-sensitive display) of the smartphone. The resulting phase difference would be shown on the smartphone screen. This could be used wherever there is a need to discover a difference in auditory phase.

Unlike a metronome, an electronic tempo trainer as presented in the embodiments described herein can visually show a musician the difference between how they play their instrument and what the set beat is. An electronic tempo trainer as described herein can give visual cues for not only the beat but where the musician is playing in relation to the beat.

These and other aspects of the embodiments will become more apparent considering the detailed specification and drawings that follow.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, explain the principles of the present invention.

FIG. 1 illustrates a block diagram of components that can be included in a tempo trainer, in accordance with features of the embodiments;

FIG. 2 illustrates a front view of an electronic tempo trainer provided with a plurality of lights set in a row, in accordance with features of the embodiments;

FIG. 3 illustrates a front view of a tempo trainer provided with a plurality of lights set in a circle, in accordance with features of the embodiments;

FIG. 4 illustrates a front view of a mobile device configured to execute a tempo trainer application, in accordance with features of the embodiments;

FIG. 5 illustrates a front view of a tempo trainer provided with a spinning disk and strobe light, in accordance with features of the embodiments;

FIGS. 6A, 6B and 6C illustrate diagrams of three connection options for a tempo trainer, in accordance with features of the embodiments; and

FIG. 7 illustrates a flow diagram of a method of using a tempo trainer, in accordance with features of the embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other issues, subject matter may be embodied as methods, devices, components, or systems. Accordingly, embodiments may, for example, take the form of hardware, software, firmware, or a combination thereof. The following detailed description is, therefore, not intended to be interpreted in a limiting sense.

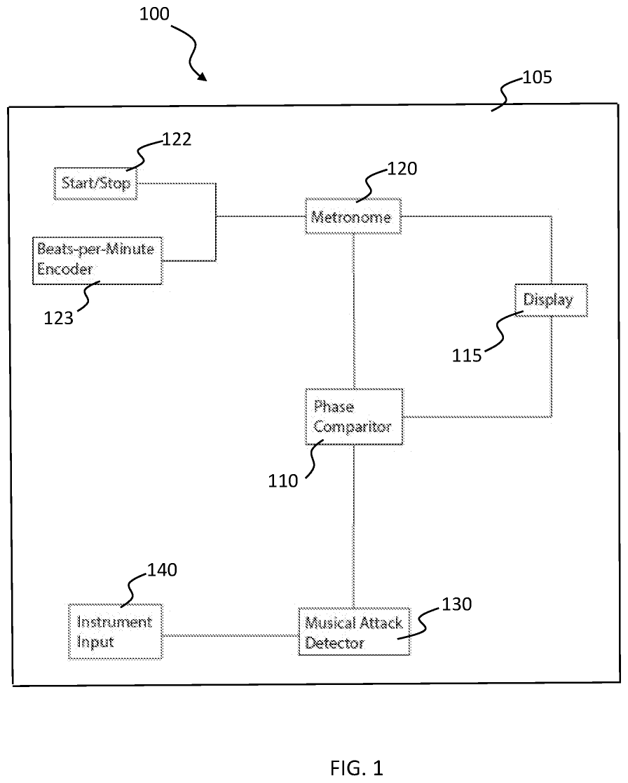

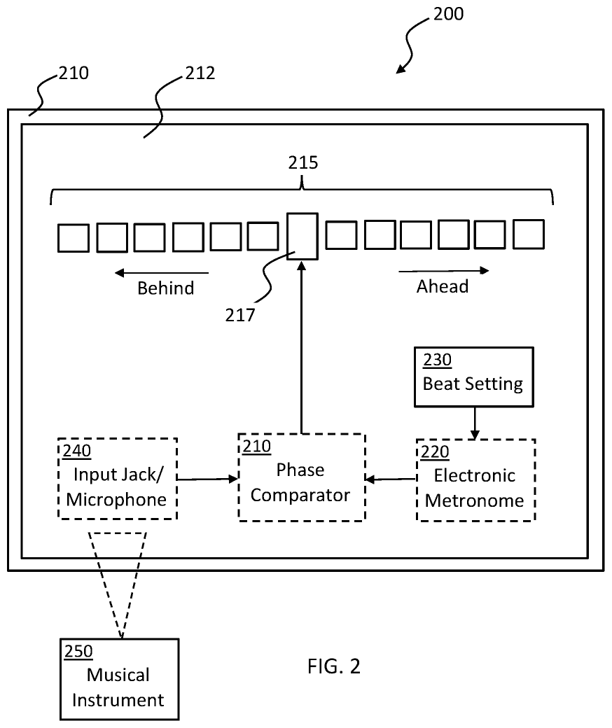

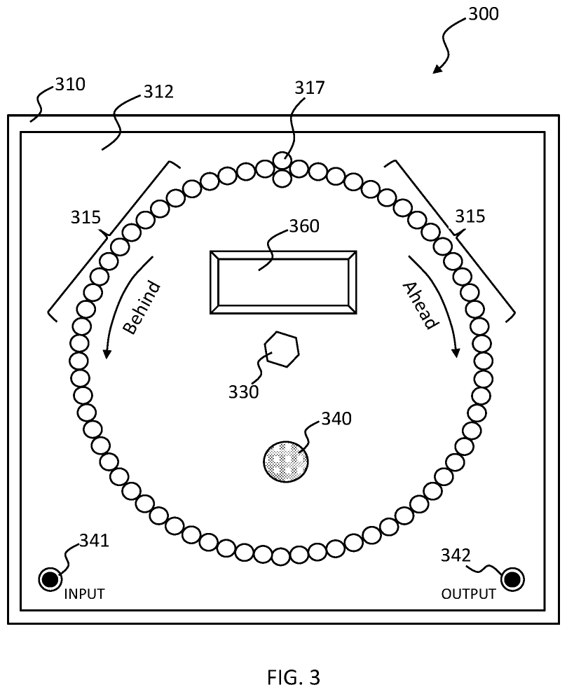

Referring to FIG. 1, illustrated is a block diagram 100 of an electronic tempo trainer 105 in accordance with an embodiment. The electronic tempo trainer 105 can include a phase comparator 110, a display 115, and metronome 120 controllable by a start/stop switch 122, a beat-per-second encoder 123, and a musical attack detector 130 configured to receive input from an instrument 140. The display 115 can be provided in the form of a plurality of lights in the form of a line or a circle displayed on the front of a housing, which is further described in FIGS. 2 and 3. The plurality of lights can also include a center light. The display (e.g., plurality of lights) can be configured to indicate, based on a comparison by phase comparator 110 of a beat set for the metronome 120 by the beats-per minute encoder 123 and an attack by a musical instrument received by musical input 140 and detected by the musical attack detector 130. The phase comparator 110 can therefore be considered an integral component of the electronic tempo trainer 105 because it can determine the time-difference between a beat of the electronic metronome 120 and an attack of a musical instrument. The beat-per minute encoder and start stop functions can be controlled manually by a user of the electronic tempo trainer 105 via a knob or by physical user input on a touch-sensitive display (e.g., the screen on a portable mobile device), which can serve as the means to set the beat of the electronic metronome. At least one of an input receptacle configured to accept a jack from the musical instrument or a microphone can be used and configured to monitor sound emanating from the musical instrument and provide the sound to the musical attack detector 130, which can then be provided as a signal to the phase comparator 110. When lights are used as the display, they can be set in a straight line (e.g., see FIG. 2) or as a circle (e.g., see FIG. 3). At least one or a portion of the plurality of lights representing display 115 can become lit either ahead of, at, or after a center light to indicate whether a musician operating the musical instrument is playing ahead of, at, or after the beat of the electronic metronone 120.

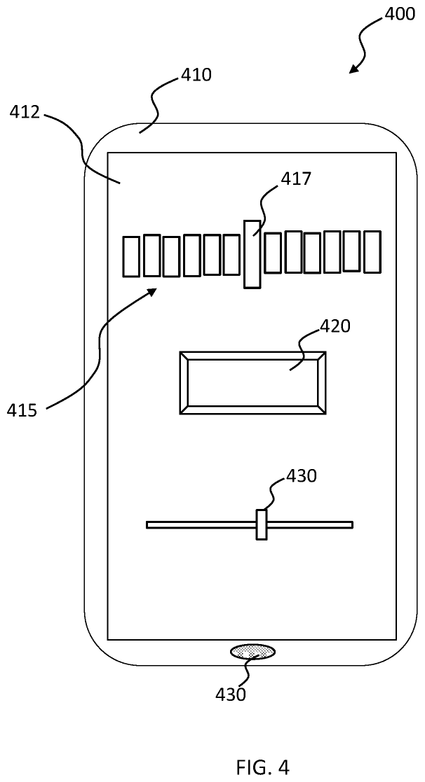

Referring to FIG. 2, illustrated is another block diagram and front view of an electronic tempo trainer 200 in accordance with the embodiments. The electronic tempo trainer 200 can include a housing 210 further including a front display surface 212. A plurality of lights 215 can be set in a line and include a center light 217. A phase comparator 210 can accept and compare phases between an electronic metronome 220 and sound from a musical instrument 250 captured by input jack/microphone 240. Input can be provided from at least one of an input jack or microphone 240 and converted into a signal representing sound from musical instrument 250. The plurality of lights can be configured to visually display the time-difference, as ascertained by the phase comparator 210, between a beat of the electronic metronome 220 that can be set by the beat setting module 230, and an attack of a musical instrument 250. The beat setting module can operate as a means to set the beat of the metronome, which can be provided in the form of a manually operated knob or in the form of controls displayed on a touch-sensitive display screen on a mobile wireless device (e.g., see FIG. 4). An input jack can be configured to accept a plug from an audio source such as the musical instrument 250 or an amplifier wherein musical instruments and microphones are plugged into, or the built-on microphone 240 can be configured to monitor for and receive sound emanating from the musical instrument 250 or other sound producing source (e.g., amplifier, microphone, electronic mixer). During operation, at least one or a portion of the plurality of lights 215 can become lit either ahead of, at, or after a center light 217 to indicate whether a musician operating the musical instrument is playing ahead of, at, or after the beat of the electronic metronone 220.

Referring to FIG. 3, illustrated is a front view of a tempo trainer 300 provided with a plurality of lights 315 formed in a circle, in accordance with features of the embodiments. A housing 310 can include a front display surface 312 whereon a plurality of lights 315 displayed on the front display surface 312 of the housing 310 in the form of a circle can include a center light 317. The plurality of lights 315 can be configured to visually display the time-difference between a beat of an electronic metronome 220 and an attack of a musical instrument 250. A knob 330 can serve as the means to set the beat of the electronic metronome 220. A phase comparator 210 can be configured to compare the beat of the electronic metronome 220 with an attack of the musical instrument 250. An input receptacle 342 can be provided to accept a jack for delivery of signal received from the musical instrument to electronic equipment such as an amplifier or a sound mixer (not shown). A microphone 340 can be provided and configured to monitor sound emanating from the musical instrument 250. During operation, at least one or a portion of the plurality of lights 315 can become lit either ahead of, at, or after a center light 317 to indicate whether a musician operating the musical instrument is playing ahead of, at, or after the beat of the electronic metronone.

Referring to FIG. 4, illustrated is a mobile wireless device 400 (e.g., smartphone or electronic tablet) that can be configured to run an application to provide features of an electronic metronome as previously described. The mobile wireless device 400 can include a display 412 (e.g., touch-sensitive display or the like as found in modern mobile devices) formed in a housing 410. A user of the mobile wireless device 400 can operate the application via user interface soft buttons 430 presented by the application for user manipulation on the display screen 412. Information regarding the application and electronic metronome functions can be provided in a portion 420 of the display 412. Sound from a musical instrument 250 can be received by a microphone 430 integrated in the housing 410. A video representation of lights 415, including a center light 417, can be displayed on the display to indicate whether a musician operating the musical instrument 250 is playing ahead of, at, or after the beat of the electronic metronome that can be set by the user of the mobile wireless device 400 via the electronic metronome application.

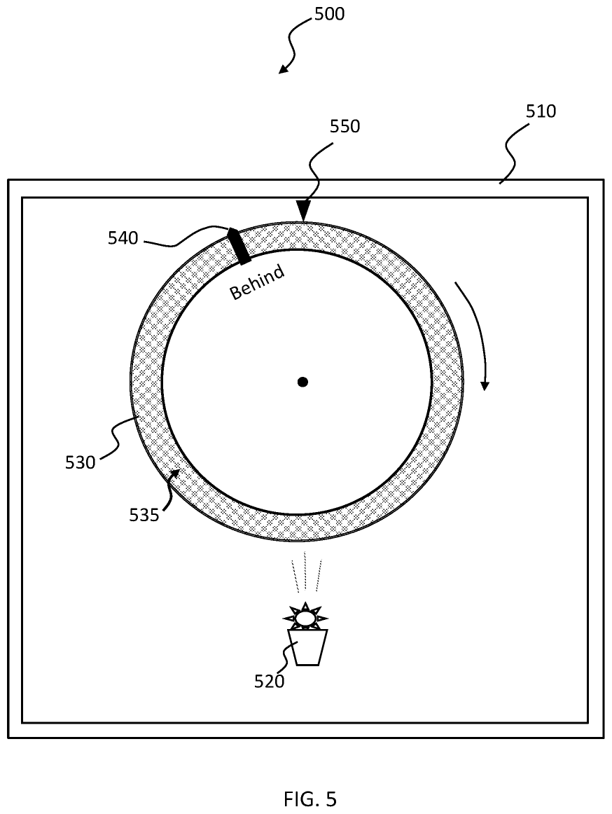

Referring to FIG. 5, illustrated is a front view of a tempo trainer 500 provided with a spinning disk 530 with an image 535 painted/etched onto its surface and operating by spinning on a housing 510 and strobe light 520 illuminating the spinning disk 530, in accordance with features of another embodiments. A fixed center line indicator 550 can be provided to visually compare with a floating marker 540 that can also be provided and will move to the left or right of the fixed center line indicator 550 in accordance with input from the phase comparator 210 after comparison of a set beat of the electronic metronome 220 and the attack received from a musical instrument 250. The floating marker 540 when provided can indicate whether a musician operating the musical instrument 250 is playing ahead of, at, or after the beat of the electronic metronome.

The image 535 provided in certain patterns can be used without a floating indicator to indicate spin rate. During operation, the disc 530 can spin at a constant rate. The strobe light 520 can flash at a rate near the time the disc 530 takes for one rotation. When the strobe light 520 flashes slower than the disc 530 rotational speed, the image 535 will appear to rotate counter clockwise. If the strobe 520 light flashes faster than the disc rotational speed, the image 535 will appear to rotate clockwise. If the strobe flashes at the exact same rate as the disc rotational speed, the image will appear stationary. The strobe light 520 flash rate is determined by the phase comparator such that the apparent image will rotate in one direction if the musician is behind the beat and the other direction if the musician is ahead of the beat. If the musician is on the beat, the strobe light 520 will flash at a rate to make the image 535 on the disc 530 appear motionless.

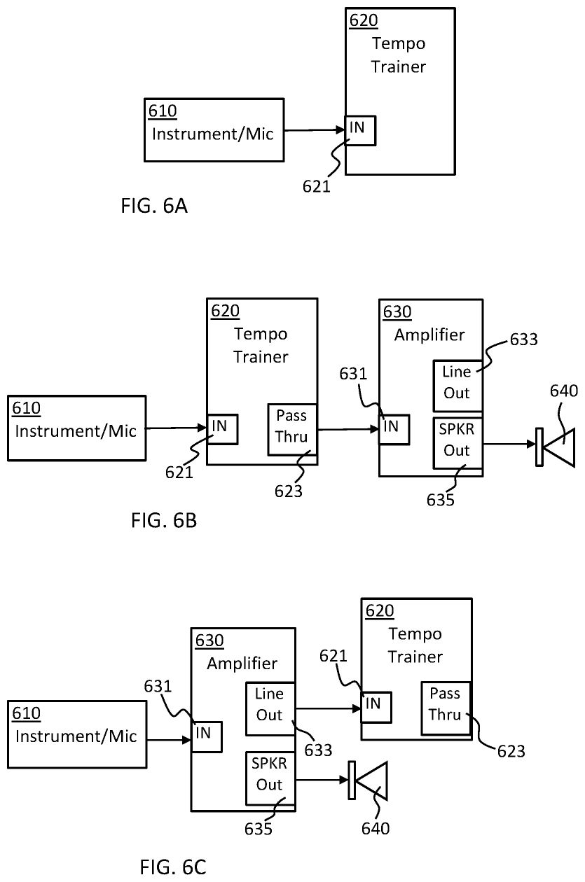

Referring to FIGS. 6A-C, illustrated are diagrams of connection options for a tempo trainer, in accordance with features of the embodiments. FIG. 6A illustrates a stand-alone connection between an instrument 610 (or microphone, etc.) and a tempo trainer 620. The instrument 610 can be connected via a cable to an input 621 associate with the tempo trainer 620. FIG. 6B illustrates a pass through configuration wherein an instrument 610 (or microphone, etc.) can be connected by cabling to the input 621 of the tempo trainer 620, and an output 623 of the tempo trainer can be connected by cabling to an input 631 of an amplifier 630. The amplifier can have a line output 633 and a speaker output 635. The speaker output 635 can be connected by wiring/cabling to speakers 640. The line out 633 can be used for connection of audio going through the amplifier 630 to a mixer, recording equipment, etc. FIG. 6C illustrates a configuration wherein an instrument 610 (or microphone, etc.) can be connected to the input 631 of the amplifier 630. The line output 633 of the amplifier 630 can be connected to the input 621 of the tempo trainer 620. The speaker output 635 of the amplifier 630 can be connected to speakers 640. the output from an amplifier. The pass thru connection (output) can be utilized to connect to additional equipment (e.g., mixer, recording equipment).

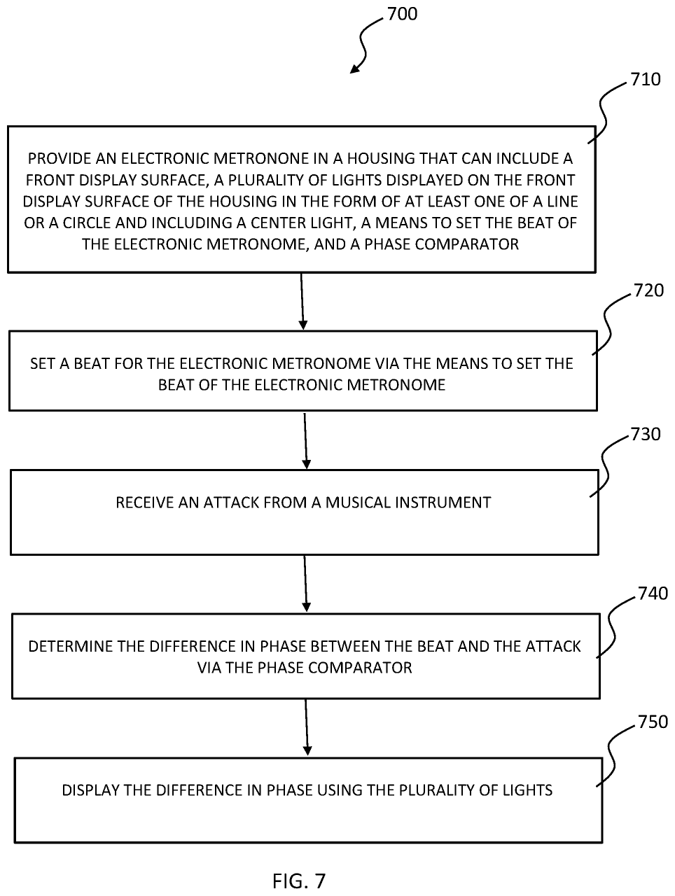

Referring to FIG. 7, illustrated is a flow diagram 700 of a method of using a tempo trainer in accordance with features of the embodiments. Referring to block 710, an electronic metronone in a housing is provided that can include a front display surface, a plurality of lights displayed on the front display surface of the housing in the form of at least one of a line or a circle and including a center light, a means to set the beat of the electronic metronome, and a phase comparator. Referring to block 720, a beat can be set for the electronic metronome via the means to set the beat of the electronic metronome. Referring to block 730, an attack from a musical instrument is received. The difference in phase between the beat and the attack is determined via the phase comparator, as shown in block 740. Then, as shown in block 650, the difference in phase is displayed using the plurality of lights. The plurality of lights can be configured to visually display the time-difference between a beat of an electronic metronome and an attack of a musical instrument with at least one or a portion of the plurality of lights becoming lit either ahead of, at, or after a center light to indicate whether a musician operating the musical instrument is playing ahead of, at, or after the beat of the electronic metronone.

The beat of the metronome can be represented by an electronic metronome signal and the phase comparator is configured to detect a difference in phase between the electronic metronome signal and the Attack. The phase-comparator can be configured to measure both a magnitude of a difference in phase between the attack and the electronic metronome signal and a before-after value representative of the attack being either before or after the electronic metronome's beat, wherein a value once determined is displayed using the plurality of lights. The plurality of lights can include any of incandescent lights, LEDs, Addressable LEDs. The center light can flash with the electronic metronome's beat, thereby providing a musician with a target for use when playing the musical instrument. Lights on either side of the center light can be lit depending on when the musician played the instrument. A portion of the plurality of lights can include colored light configured to indicate at least one of four possibilities including: 1) Center Light—electronic metronome beat but musician missed the beat or isn't playing; 2) Center Light—electronic metronome beat AND musician played on time; 3) Left Lights—musician played early, or before the beat; 4) Right Lights—Musician played late, or after the beat. A circle of lights can enable musicians to view playing accuracy when playing multiple times per beat. The beat of the electronic metronome can be set as at least one of: a quarter note with one light it up per beat, eighth notes with two lights lit up per beat, triplets with three lights lit up, and sixteenth notes with four lights lit up per beat.

It should be appreciated that variations of the above-disclosed embodiments and examples and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. An electronic tempo trainer, comprising:
a housing including a front display surface;
a plurality of lights displayed on the front display surface of the housing in the form of at least one of a line or a circle and including a center light, wherein the plurality of lights are configured to visually display the time-difference between a beat of an electronic metronome and an attack of a musical instrument;
a means to set the beat of the electronic metronome;
a phase comparator configured to compare the beat of the metronome with the attack of the musical instrument; and
at least one of an input receptacle configured to accept a plug from the musical instrument or a microphone configured to monitor sound emanating from the musical instrument;
wherein at least one or a portion of the plurality of lights become lit either ahead of, at, or after a center light to indicate whether a musician operating the musical instrument is playing ahead of, at, or after the beat of the electronic metronone.

2. The electronic tempo trainer of claim 1, further comprising an output jack configured to pass a signal representing the attack of the musical instrument onto additional electronic equipment.

3. The electronic tempo trainer of claim 2, wherein the additional electronic equipment is at least one of an amplifier or an electronic mixer.

4. The electronic tempo trainer of claim 2, wherein the input and output jacks comprise of ¼ inch input jacks.

5. The electronic tempo trainer of claim 1, wherein the means to set the beat of the electronic metronome is a rotary knob installed on the housing and coupled to the phase comparator.

6. The electronic tempo trainer of claim 5, wherein the rotary knob is further configured to start and stop operation of the electronic metronome.

7. The electronic tempo trainer of claim 1, wherein the beat of the metronome is represented by an electronic metronome signal and the phase comparator is configured to detect a difference in phase between the electronic metronome signal and the Attack.

8. The electronic tempo trainer of claim 1, wherein the phase-comparator is configured to measure both a magnitude of a difference in phase between the attack and the electronic metronome signal and a before-after value representative of the attack being either before or after the electronic metronome's beat, wherein a value once determined is displayed using the plurality of lights.

9. The electronic tempo trainer of claim 1, wherein the plurality of lights include any of incandescent lights, LEDs, Addressable LEDs.

10. The electronic tempo trainer of claim 1, wherein the center light flashes with the electronic metronome's beat thereby providing a musician with a target for use when playing the musical instrument.

11. The electronic tempo trainer of claim 1, wherein lights on either side of the center light are lit depending on when the musician played the instrument.

12. The electronic tempo trainer of claim 1, wherein a portion of the plurality of lights include colored light configured to indicate at least one of four possibilities including: 1) Center Light—electronic metronome beat but musician missed the beat or isn't playing; 2) Center Light—electronic metronome beat AND musician played on time; 3) Left Lights—musician played early, or before the beat; 4) Right Lights—Musician played late, or after the beat.

13. The electronic tempo trainer of claim 1, wherein a circle of lights enable musicians to view playing accuracy when playing multiple times per beat.

14. The electronic tempo trainer of claim 13, wherein the beat of the electronic metronome is settable as at least one of: a quarter note with one light it up per beat, eighth notes with two lights lit up per beat, triplets with three lights lit up, and sixteenth notes with four lights lit up per beat.

15. The electronic tempo trainer of claim 14, wherein a pattern of the circle can indicate to the musicians how accurately an instrument was played.

16. An electronic tempo trainer, comprising:
a housing including a front display surface;
a phase comparator configured to compare a beat of an electronic metronome with an attack from a musical instrument;
a means to set the beat of the electronic metronome;
a spinning disk with a pattern formed on a surface of the spinning disk, and a strobe light formed on the display, wherein the spinning disk is configured to spin at a constant rotational speed while the strobe is configured to flash at a rate to make a pattern formed on the disk move clockwise indicating play that is ahead of the beat or counterclockwise indicating play that is behind the beat, wherein a rate of apparent spin can be proportional to the difference between the attack and the beat; and
at least one of an input receptacle configured to accept a plug from the musical instrument or a microphone configured to monitor sound emanating from the musical instrument as an input to the phase comparator.

17. The electronic tempo trainer of claim 16, further comprising at least one of an input receptacle configured to accept a plug from the musical instrument or a microphone configured to monitor sound emanating from the musical instrument.

18. A method of using a tempt trainer, comprising:
providing an electronic metronone in a housing including a front display surface, a plurality of lights displayed on the front display surface of the housing in the form of at least one of a line or a circle and including a center light, a means to set the beat of the electronic metronome, and a phase comparator;
setting a beat for the electronic metronome via the means to set the beat of the electronic metronome;
receiving an attack from a musical instrument;
comparing the difference in phase between the beat and the attack via the phase comparator; and
displaying the difference in phase using the plurality of lights, wherein the plurality of lights are configured to visually display the time-difference between a beat of an electronic metronome and an attack of a musical instrument with at least one or a portion of the plurality of lights becoming lit either ahead of, at, or after a center light to indicate whether a musician operating the musical instrument is playing ahead of, at, or after the beat of the electronic metronone.

19. The method of claim 18, wherein the beat of the metronome is represented by an electronic metronome signal and the phase comparator is configured to detect a difference in phase between the electronic metronome signal and the Attack.

20. The method of claim 18, wherein the phase-comparator is configured to measure both a magnitude of a difference in phase between the attack and the electronic metronome signal and a before-after value representative of the attack being either before or after the electronic metronome's beat, wherein a value once determined is displayed using the plurality of lights.

21. The method of claim 18, wherein the center light flashes with the electronic metronome's beat thereby providing a musician with a target for use when playing the musical instrument.

22. The electronic tempo trainer of claim 18, wherein lights on either side of the center light are lit depending on when the musician played the instrument.

23. The electronic tempo trainer of claim 18, wherein a portion of the plurality of lights include colored light configured to indicate at least one of four possibilities including: 1) Center Light—electronic metronome beat but musician missed the beat or isn't playing; 2) Center Light—electronic metronome beat AND musician played on time; 3) Left Lights—musician played early, or before the beat; 4) Right Lights—Musician played late, or after the beat.
